(19) United States
(12) Patent Application Publication
(10) Pub. No.: US 2024/0109359 A1
(43) Pub. Date: Apr. 4, 2024

(54) HEAT-SENSITIVE RECORDING MATERIAL

(71) Applicant: SANKO CO., LTD., Kurume-shi, Fukuoka (JP)

(72) Inventors: Yoshimi ISHIBASHI, Nishinomiya-shi, Hyogo (JP); Takamichi OISHI, Ibaraki-shi, Osaka (JP); Yoshitaka FUJINO, Takatsuki-shi, Osaka (JP); Ryoichi KINISHI, Ibaraki-shi, Osaka (JP)

(21) Appl. No.: 17/768,164

(22) PCT Filed: Jun. 11, 2020
(86) PCT No.: PCT/JP2020/023046

§ 371 Date: Apr. 11, 2022

(30) Foreign Application Priority Data
Oct. 18, 2019 (JP) 2019-191109

(51) Int. Cl. B41M 5/333; B41M 5/337

(52) U.S. Cl. CPC B41M 5/3336; B41M 5/3375

(57) ABSTRACT

The purpose of the present disclosure is to improve the sensitivity of 4,4′-dihydroxydiphenylsulfone, which is a developer, in a heat-sensitive recording material. The present disclosure provides a heat-sensitive recording material that uses at least one selected from 1,2-bis(phenoxy)ethane, 1,2-bis(3-methylphenoxy)ethane, benzyloxynaphthalene, and oxalic acid di-p-methylbenzyl ester as a sensitizer for 4,4′-dihydroxydiphenylsulfone, and further includes benzoin as a sensitization aid.

### TECHNICAL FIELD

The present disclosure relates to a heat-sensitive recording material, and more particularly relates to a heat-sensitive recording material that uses 4,4′-dihydroxydiphenylsulfone as a developer.

### BACKGROUND ART

Heat-sensitive recording materials obtained by forming, on a support body of paper, plastic film, or the like, a heat-sensitive recording layer including a basic dye (leuco dye) that is from colorless to a light color at room temperature, and a developer that is capable of reacting with the basic dye and colorizing as a result of heating are known in the art. Such heat-sensitive recording materials enable printing without inks or toners, and are currently widely used in the printing of receipts, facsimile paper, tickets, and the like. Additives such as sensitizers can be further added to heat-sensitive color developing agents.

In the heat-sensitive recording layer, the basic dye (leuco dye) that is from colorless to a light color at room temperature and the developer are each dispersed in a solid state and, as such, do not react when coming in contact with each other alone. However, when heat energy (joule heat) of a thermal head, thermal pen, or the like is applied to the heat-sensitive recording layer, these components melt and react and, as a result, the heated portion develops color which allows printing to be carried out.

Color development at low temperatures is one characteristic that is required of such heat-sensitive recording materials. Other characteristics include the whiteness of the background before printing, the whiteness of the background and the color density of the printed portion after applying heat energy for printing, and the storage stability of the printed portion. Typically, heat-sensitive recording materials are stored at room temperature in a state in which external energy such as light exposure is not applied. Regardless of this, there is a possibility that the leuco dye and the developer will react and, while slight, color will develop. The phrase “storage stability of the printed portion” refers to the characteristic of the printed portion to not disappear when coming in contact with water, oils, or plasticizers when the printed portion is placed in a high-humidity environment or the like.

The required characteristics of the printed portion formed by the heat-sensitive recording material are affected by the main components of the heat-sensitive color developing agent, namely the basic dye, developer, and sensitizer. Among these, the effects of the developer are great. As such, synthetic compounds derived from petrochemicals such as phenolic compounds, sulfonylurea compounds, and the like have been proposed as developers that satisfy the required characteristics described above. Of these, many types of phenol compounds have been developed and put into practical use.

In particular, 4,4′-dihydroxydiphenylsulfone is commonly and widely used due to being inexpensive and having excellent storability of the printed portion with respect to water and oil, and is the most commonly used developer, particularly for receipts.

However, due to 4,4′-dihydroxydiphenylsulfone having a high melting point at 248° C., it is difficult to obtain color development sensitivity. Moreover, since 4,4′-dihydroxydiphenylsulfone is different from other phenolic developers in that it has low compatibility with the various types of sensitizers, it is difficult to improve the sensitivity of 4,4′-dihydroxydiphenylsulfone. While various types of sensitizers for improving the sensitivity of heat-sensitive recording materials have been proposed, at present, diphenylsulfone, which is compatible with 4,4′-dihydroxydiphenylsulfone, is the only sensitizer that is practically being used.

Patent Literature 1 mentions benzoin in addition to diphenylsulfone as a sensitizer. Patent Literature 2 and 3 disclose heat-sensitive recording materials in which benzoin is used as the sensitizer of a specific developer. However, when benzoin is used alone as a sensitizer, there is a problem in that crystals of benzoin grow rapidly in the printed portion, the so-called “powdering” phenomenon is observed, and the apparent density decreases. The powdering phenomenon is particularly significant when printing is carried out using high printing energy.

### CITATION LIST

### Patent Literature

Patent Literature 1: Examined Japanese Patent Application Publication No. S59-25673
Patent Literature 2: International Publication No. WO2016/125460A1
Patent Literature 3: Unexamined Japanese Patent Application Publication No. 2019-136983

### SUMMARY OF INVENTION

### Technical Problem

The present disclosure is made in light of the situation described above and provides a heat-sensitive recording material having increased color development sensitivity in a system using 4,4′-dihydroxydiphenylsulfone as a developer.

### Solution to Problem

The inventors of the present disclosure arrived at the present disclosure by conducting diligent research on sensitizers and sensitization aids for the purpose of improving the sensitivity of 4.4′-dihydroxydiphenylsulfone, which is an inexpensive developer.

The present disclosure is a heat-sensitive recording material comprising a basic dye that is colorless to a light color at room temperature, and, as a developer, 4,4′-dihydroxydiphenylsulfone which is capable of reacting with the basic dye and colorizing as a result of heating; wherein at least one selected from 1,2-bis(phenoxy) ethane, 1,2-bis(3-methylphenoxy) ethane, benzyloxynaphthalene, and oxalic acid di-p-methylbenzyl ester is used as a sensitizer, and benzoin is further added as a sensitization aid.

### Advantageous Effects of the Invention

The present disclosure can provide a heat-sensitive recording material having high sensitivity by using at least one selected from 1,2-bis(phenoxy) ethane, 1,2-bis(3-methylphenoxy) ethane, benzyloxynaphthalene, and oxalic acid di-p-methylbenzyl ester as a sensitizer, and using benzoin as a sensitization aid to improve the sensitivity of the 4,4′-dihydroxydiphenylsulfone as a developer.

### DESCRIPTION OF EMBODIMENTS

A heat-sensitive recording material of the present disclosure is obtained by providing, on a support body, a heat-sensitive recording layer including a basic dye that is colorless to a light color at room temperature, a developer that is capable of reacting with the basic dye and colorizing as a result of heating, a sensitizer, and a sensitization aid; wherein the developer is 4,4′-dihydroxydiphenylsulfone, the sensitizer is at least one selected from 1,2-bis(phenoxy) ethane, 1,2-bis(3-methylphenoxy) ethane, benzyloxynaphthalene, and oxalic acid di-p-methylbenzyl ester, and the sensitization aid is benzoin.

In the heat-sensitive recording material of the present disclosure, examples of the basic dye that is colorless to a light color at room temperature include triphenylmethane-based, fluorene-based, diphenylmethane-based, spiro-based, fluorene-based, and thiazine-based compounds, and the basic dye can be selected from conventionally known leuco dyes.

While not limited thereto, the leuco dye that can be used in the present disclosure can be selected from, for example, 3,3-bis(p-dimethylaminophenyl)-6-dimethylaminophthalide, 3,3-bis(p-dimethylaminophenyl) phthalide, 3-(4-diethylamino-2-ethoxyphenyl)-3-(1-ethyl-2-methylindol-3-yl)-4-azaphthalide, 3,3-bis(p-methylaminophenyl)-6-dimethylaminophthalide, 3-diethylamino-7-dibenzylaminobenzo[α]fluorane, 3-(1-ethyl-2-methylindol-3-yl)-3-(4-diethylamino-2-n-hexyloxyphenyl-4-azaphthalide, 3-(1-ethyl-2-methylindol-3-yl)-3-(4-diethylamino)-2-methylphenyl-4-azaphthalide, 3-(4-diethylaminophenyl)-3-(1-ethyl-2-methylindol-3-yl)phthalide, 3-(2-methyl-1-n-octylindre-3-yl)-3-(4-diethylamino-2-ethoxyphenyl)-4-azaphthalide, 3-(N-ethyl-N-isopentylamino)-6-methyl-7-anilinofluorane, 3-diethylamino-6-methyl-7-anilinofluorane, 3-diethylamino-6-methyl-7-(o,p-dimethylanilino)fluorane,

3-(N-ethyl-N-p-toluidino)-6-methyl-7-anilinofluorane, 3-pyrrolidine-6-methyl-7-anilinofluorane, 3-dibutylamino-6-methyl-7-anilinofluorane, 3-(N-cyclohexyl-N-methylamino)-6-methyl-7-anilinofluorane, 3-diethylamino-7-(o-chloroanilino)fluorane, 3-diethylamino-7-(m-trifluoromethylanilino)fluorane, 3-di(n-pentyl)amino-6-methyl-7-anilinofluorane, 3-[N-(3-ethoxypropyl)-N-ethylamino]-6-methyl-7-anilinofluorane, 3-(N-n-hexyl-N-ethylamino)-7-(o-chloroanilino)fluorane, 3-(N-ethyl-N-2-tetrahydrofurfurylamino)-6-methyl-7-anilinofluorane, 2,2-bis{4-[6′-(N-cyclohexyl-N-methylamino)-3′-methylspiro[phthalide-3,9′-xanthene]-2′-ylamino]phenyl}propane, 3-dibutylamino-7-(o-chloroanilino)fluorane,
3,6-dimethoxyfluoran, 3-pyrrolidineno-6-chlorofluorane, 3-diethylamino-6-methyl-7-chlorofluorane, 3-diethylamino-7-chlorofluorane, 3-diethylamino-7,8-dibenzofluorane, 3-diethylamino-6,7-dimethylfluorane, 3-(N-methyl-p-toluizino)-7-methylfluorane, 3-(N-methyl-N-isoamylamino)-7,8-benzofluorane, 3,3′-bis(1-n-amyl-2-methylindre-3-yl)phthalide, 3-(N-methyl-N-isoamylamino)-7-phenoxyfluorane, 3,3′-bis(1-n-butyl-2-methylindre-3-yl)phthalide, 3,3′-bis(1-ethyl-2-methylindre-3-yl)phthalide, 3,3′-bis(p-dimethylaminophenyl)phthalide, 3-(N-ethyl-N-p-trillamino)-7-(N-phenyl-N-methylamino)fluorane, 3-diethylamino-7-anilinofluorane, 3-diethylamino-7-benzylaminofluorane, 3-pyrrolidineno-7-dibenzylaminofluorane, and the like.

However, the present disclosure is not limited thereto and two or more types of leuco dyes may be used.

The heat-sensitive recording material of the present disclosure includes 4,4′-dihydroxydiphenylsulfone as the developer and, in order to improve the sensitivity of the developer, uses at least one selected from 1,2-bis(phenoxy)ethane, 1,2-bis(3-methylphenoxy)ethane, benzyloxynaphthalene, and oxalic acid di-p-methylbenzyl ester as the sensitizer. Furthermore, a heat-sensitive recording material having high sensitivity can be provided by using benzoin as the sensitization aid.

Conventionally, when benzoin is used as the sensitizer for 4,4′-dihydroxydiphenylsulfone, the powdering phenomenon occurs and the color density after printing declines. However, the inventors of the present disclosure surprisingly discovered that, by using at least one selected from 1,2-bis(phenoxy)ethane, 1,2-bis(3-methylphenoxy)ethane, benzyloxynaphthalene, and oxalic acid di-p-methylbenzyl ester, which have low compatibility with 4,4′-dihydroxydiphenylsulfone, as the sensitizer, and using benzoin as the sensitization aid, compatibility is improved, color development is improved, and the powdering phenomenon does not occur.

A conventionally known storage stabilizer can be used in the heat-sensitive recording material of the present disclosure. While not limited thereto, examples of the storage stabilizer that can be used in the present disclosure include hindered phenolic compounds such as 2,2′-methylenebis(4-methyl-6-tert-butylphenol), 2,2′-methylenebis(4-ethyl-6-tert-butylphenol), 2,2′-etilidenebis(4,6-di-tert-butylphenol), 4,4′-thiobis(2-methyl-6-tert-butylphenol), 4,4′-butylidene bis(6-tert-butyl-m-cresol), 1,1,3-tris(2-methyl-4-hydroxy-5-tert-butylphenyl)butane, 1,1,3-tris(2-methyl-4-hydroxy-5-cyclohexylphenyl)butane, 4,4′-bis[(4-Methyl-3-phenoxycarbonylaminophenyl)ureido] diphenylsulfone, tris(2,6-dimethyl-4-tert-butyl-3-hydroxybenzyl) isocyanate, 4,4′-thiobis(3-methylphenol), 4,4′-dihydroxy-3,3′,5,5′-tetrabromodiphenyl sulfone, 4,4′-dihydroxy-3,3′,5,5′-tetramethyldiphenyl sulfone, 2,2′-bis(4-hydroxy-3,5-dibromophenyl) propane, 2,2′-bis(4-hydroxy-3,5-dichlorophenyl)propane, 2,2′-bis(4-hydroxy-3,5-dimethylphenyl)propane, and the like; 1,4-diglycidyloxybenzene, 4,4′-diglycidyloxydiphenyl sulfone, 4-benzyloxy-4′-(2-methylglycyloxy) diphenyl sulfone, glycidyl terephthalate; epoxy compounds such as Bisphenol A type epoxy resin type, cresol novolac type epoxy resin, phenol novolac type epoxy resin, and the like; sodium salts or polyvalent metal salts of N,N′-di-2-naphthyl-p-phenylenediamine and 2,2′-methylenebis(4,6-di-tert-butylphenyl) phosphate; bis(4-ethyleneiminecarbonylaminophenyl)methane, 4,4′-bis[(4-methyl-3-phenoxycarbonylaminophenyl)ureido] diphenyl sulfone; diphenyl sulfone cross-linked compounds expressed by General Formula (1):

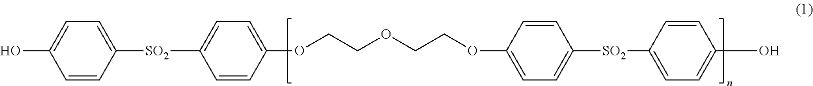

(where n is an integer of 1 to 7), and the like. These storage stabilizers contribute to the storage stability of the printed portion of the heat-sensitive recording material.

Of these storage stabilizers, it is preferable that at least one selected from 1,1,3-tris(2-methyl-4-hydroxy-5-tert-butylphenyl) butane, 1,1,3-tris(2-methyl-4-hydroxy-5-cyclohexylphenyl) butane, 4,4′-bis[(4-methyl-3-phenoxycarbonylaminophenyl)ureido] diphenyl sulfone, and the diphenyl sulfone cross-linked compound expressed by General Formula (1) is included. Including these storage stabilizers further improves water resistance, oil resistance, and plasticizer resistance of the printed portion of the heat-sensitive recording material.

Furthermore, fatty acid amides such as stearic acid amides, bisstearic acid amides, and palmitic acid amides can be added to improve the sensitivity.

While not limited thereto, examples of aids include dispersants such as sodium dioctiol succinate, sodium dodecylbenzene sulfonate, sodium lauryl alcohol sulfate, fatty acid metal salts, and the like; waxes such as zinc stearate, calcium stearate, polyethylene wax, carnauba wax, paraffin wax, and ester wax; hydrazide compounds such as adipic acid dihydrazide; water resistant agents such as glyoxal, boric acid, dialdehyde starch, methylol urea, glyoxylate, epoxy compounds, and the like; defoamers; coloring dyes; fluorescent dyes; pigments; and the like.

Examples of a binder used in the heat-sensitive recording layer in the present disclosure include polyvinyl alcohols having a degree of polymerization of 200 to 1900 such as fully saponified polyvinyl alcohol, partially saponified polyvinyl alcohol, carboxy-modified polyvinyl alcohol, diacetone-modified polyvinyl alcohol, acetoacetyl-modified polyvinyl alcohol, amide-modified polyvinyl alcohol, sulfonic acid modified polyvinyl alcohol, butyral-modified polyvinyl alcohol, and the like; cellulose derivatives such as hydroxyethyl cellulose, methyl cellulose, carboxymethyl cellulose, styrene-maleic anhydride copolymer, styrene-butadiene copolymer, ethyl cellulose, acetyl cellulose, and the like; polyvinyl acetate, polyacrylamide, polyacrylic acid ester, polyvinyl butyral polystyrol, and copolymers thereof; polyamide resin; silicone resin; petroleum resin; terpene resin; ketone resin; chromane resin; and the like. A single binder may be used, or two or more types of binders may be used. The binder can be used dissolved in a solvent or can be used emulsified or dispersed in a paste-like state in water or another medium.

Examples of a pigment compounded in the heat-sensitive recording layer include inorganic or organic pigments such as silica, calcium carbonate, kaolin, calcined kaolin, caustic soil, talc, titanium oxide, zinc oxide, aluminum hydroxide, polystyrene resin, urea-formalin resin, styrene-methacrylic acid copolymer, styrene-butadiene copolymer, hollow plastic pigment, and the like; and the like.

In the heat-sensitive recording layer of the present disclosure, from the perspective of color density, the content of the 4,4′-dihydroxydiphenylsulfone is preferably from 0.3 to 5 parts by mass, and more preferably from 0.4 to 3 parts by mass with respect to 1 part by mass of the basic dye of the heat-sensitive recording layer.

Furthermore, when the leuco dye is used, from 0.2 to 4 parts by mass of the sensitizer with respect to 1 part by mass of the leuco dye is suitable, and it is suitable that the content of the binder is from 5 to 50% by mass of the total solid content.

The compounding ratio of the sensitizer to the sensitization aid is preferably in a range of 98:2 to 40:60 and is more preferably from 90:10 to 60:40.

The content of the storage stabilizer is preferably from 2.5 to 100 parts by mass and more preferably from 5 to 50 parts by mass with respect to 100 parts by mass of all of the developer.

The types and contents of the basic dye, the developer, the sensitizer, the aid, the binder, the pigment, and other additives used in the heat-sensitive recording layer in the present disclosure are appropriately determined in accordance with the quality and characteristics required from the heat-sensitive recording layer.

The leuco dye, the developer, the sensitizer, the sensitization aid and, as necessary, the storage stabilizer and the like used in the heat-sensitive recording layer in the present disclosure are, in one example, used finely dispersed by a stirring/crushing machine such as a ball mill, an attritor, or a sand mill with water as the dispersing medium such that the average particle size is 2 μm or less and preferably 1 μm or less.

A heat-sensitive recording coating is prepared by mixing/stirring, as necessary, the pigment, the binder, the aids, and the like into the mixture dispersion including the finely dispersed mixture of the leuco dye, the developer, the sensitizer, the sensitization aid and, as necessary, the storage stabilizer, and the like.

The heat-sensitive recording coating prepared in this manner is applied to the support body such that the coated amount after drying is about 1.5 to 12 g/m² and preferably about 3 to 7 g/m², and dried. Thus, the heat-sensitive recording layer is formed.

Paper, recycled paper, synthetic paper, plastic film, nonwoven fabric, metal foil, and the like can be used as the support body. Additionally, a composite sheet obtained by combining these materials can be used.

The heat-sensitive recording layer may be laminated on the support body by directly applying the heat-sensitive recording coating prepared as described above to the support body, or an undercoat layer may be formed first on the support body, and the heat-sensitive recording layer may be formed on the undercoat layer. Providing the undercoat layer prevents residue from adhering to the thermal head which, in turn, makes it possible to improve print quality and sensitivity. It is sufficient that the composition of the undercoat layer is selected appropriately in accordance with the purpose but, in general, the composition includes a binder, an organic pigment, an inorganic pigment, hollow fine particles, foam particles, and the like. A foam resin can be used for the undercoat layer in order to further improve the sensitivity.

A resin such as that used in the heat-sensitive recording layer can be used as the binder of the undercoat layer. Specifically, starches such as oxidized starch, esterified starch, etherified starch, and the like; cellulose resins such as methyl cellulose, carboxy cellulose, methoxy cellulose, methoxy cellulose, hydroxyethyl cellulose, and the like; casein; gelatin; polyvinyl alcohols such as completely (or partially) saponified polyvinyl alcohol, carboxy-modified polyvinyl alcohol, acetacetyl-modified polyvinyl alcohol, silicon-modified polyvinyl alcohol, amide-modified polyvinyl alcohol, sulfonic acid-modified polyvinyl alcohol, butyral-modified polyvinyl alcohol, and the like; styrene-maleic anhydride copolymer latex; styrene-butadiene copolymer latex; vinyl acetate resin latex; urethane resin latex; acrylic resin latex; and the like can be used.

Examples of the inorganic pigment included in the undercoat layer include metal oxides such as aluminum hydroxide, magnesium hydroxide, barium sulfate, aluminum silicate, calcium carbonate, and the like; metal compounds such as metal hydroxides, sulfates, carbonates, and the like; amorphous silica; calcined kaolin; inorganic white pigments such as talc; and the like. Of these, calcined kaolin, in particular, has excellent color development sensitivity, sensitivity, and residue absorption and, as such, is preferably used. Note that it is preferable that an inorganic pigment having a particle size of about 0.5 to 3.0 μm is used.

Examples of the organic pigment included in the undercoat layer include spherical resin particles (so-called dense resin particles), hollow particles, resin particles having through-holes, a resin that has an opening such as that obtained by cutting a portion of hollow resin particles on a modified surface, and the like. A hollow resin is preferably used from the perspective of increasing the recording density.

In order to obtain both sensitivity and residue adhesion in a well-balanced manner, an inorganic pigment system and an organic pigment system are typically used together, and a use ratio of the inorganic pigment to the organic pigment in terms of mass is preferably about 90:10 to 30:70 and is more preferably 70:30 to 50:50.

An undercoat layer coating, in which water is typically used as the dispersion medium, obtained by mixing/stirring the binder and at least one selected from the inorganic pigment and the organic pigment, is applied to the substrate body such that the coated amount after drying is about 1 to 20 g/m², and preferably about 5 to 15 g/m², and dried. Thus, the undercoat layer is formed. It is preferable that the content of the binder is about 5 to 40% by mass and that the content of the pigment is about 10 to 95% by mass with respect to the total solid content of the undercoat layer. Furthermore, as necessary, lubricants such as zinc stearate, calcium stearate, paraffin wax, and the like; and various aids such as fluorescent dyes, coloring dyes, surfactants, cross-linking agents, and the like can be added to the undercoat layer coating.

A single layer of the undercoat layer may be formed or, in some cases, two or more layers may be formed.

The application method for forming the heat-sensitive layer is not particularly limited, and, for example, application can be carried out by an appropriate application method such as air knife coating, baribar coating, pure blade coating, rod blade coating, curtain coating, die coating, slide velvet coating, offset gravure coating, 5-roll coating, and the like.

Additionally, a protective layer, in which a binder formed from a film-forming polymer substance is a main component, may be formed on the heat-sensitive recording layer for the purpose of enhancing the storage stability. In one example, a protective layer coating is prepared using water as a medium by mixing/stirring a binder component, an organic pigment or an inorganic pigment and, as necessary, aids. The binders, the pigments, and the aids used in the heat-sensitive recording layer described above can be used for the binder, the pigments, and the aids used in the protective layer.

Furthermore, a glossy layer may be formed on the protective layer. For the glossy layer, examples of methods include a method in which a coating liquid including an electron beam or UV curable compound is applied and, then, an electron beam or UV light is emitted to cure the coating liquid; a method using ultra-fine particle core-shell acrylic resin; and the like.

Furthermore, an antistatic layer may be formed on a back surface side of the support body.

As with the heat-sensitive recording layer, the coatings for forming the undercoat layer, the protective layer, the glossy layer, and the like can be applied by an appropriate application method such as pure blade coating, rod blade coating, curtain coating, offset gravure coating, and the like, and dried. Thus, the various layers are formed.

Various known processing techniques in the field of heat-sensitive recording material manufacturing, such as super calender processing, may be added, as appropriate, after the various layers are formed.

### EXAMPLES

In the following, the present disclosure is described using examples and comparative examples, but the present disclosure is not limited thereto. Note that, in the examples, the terms “part” and “%” express “parts by mass” and “% by mass.”

### Example 1

The heat-sensitive recording material was fabricated by the following operations.

### Creation of Undercoat Layer Coating

100 parts of plastic hollow particles (product name: ROPAQUE SN-1055, void volume: 55%, solid content: 26.5%), 100 parts of a 50% dispersion of calcined kaolin, 25 parts of a styrene-butane latex (product name: L-1571, solid content: 48%), 50 parts of a 10% aqueous solution of oxidized starch, and 20 parts of water were mixed to create an undercoat layer coating.

### Creation of Heat-Sensitive Recording Coating

Firstly, using the compositions illustrated in Table 1, a liquid A (leuco dye dispersion), a liquid B (developer dispersion), a liquid C (sensitizer dispersion), and a liquid D (sensitization aid dispersion) were prepared by mixing a 10% polyvinyl alcohol aqueous solution, as a dispersion binder, with each of 4,4′-dihydroxydiphenylsulfone, which is the developer, and 1,2-bis(phenoxy)ethane, which is the sensitizer.

TABLE 1
Liquid A (leuco dye dispersion)

| | | |
|---|---|---|
| 3-(N,N-dibutylamino)-6-methyl-7- | 10 | parts |
| anilinofluorane | | |
| 10% polyvinyl alcohol aqueous solution | 10 | parts |
| Water | 16.7 | parts |

Liquid B (developer dispersion)

| | | |
|---|---|---|
| 4,4′-dihydroxydiphenylsulfone | 20 | parts |
| 10% polyvinyl alcohol aqueous solution | 20 | parts |
| Water | 33.3 | parts |

Liquid C (sensitizer dispersion)

| | | |
|---|---|---|
| 1,2-bis(phenoxy)ethane | 20 | parts |
| 10% polyvinyl alcohol aqueous solution | 20 | parts |
| Water | 33.3 | parts |

Liquid D (sensitization aid dispersion)

| | | |
|---|---|---|
| Benzoin | 20 | parts |
| 10% polyvinyl alcohol aqueous solution | 20 | parts |
| Water | 33.3 | parts |

Each of the liquid A, the liquid B, the liquid C, and the liquid D dispersions was pulverized using a sand grinder until the average particle size thereof was 1 μm or less, and the obtained dispersions were mixed at the ratios illustrated in Table 2. Thus, a mixture dispersion was obtained.

TABLE 2
Mixture dispersion

| | |
|---|---|
| Liquid A (leuco dye dispersion) | 36.7 parts |
| Liquid B (developer dispersion liquid) | 73.3 parts |
| Liquid C (sensitizer dispersion liquid) | 55.0 parts |
| Liquid D (sensitization aid dispersion liquid) | 18.3 parts |

A composition including 20 parts of aluminum hydroxide (product name: HYGILITE H-42), 10 parts of amorphous silica (product name: MIZUKASIL p-605), 20 parts a 10% solution of oxidized starch, 15 parts of a zinc stearate dispersion (product name: HYDRIN Z-8-36), and 20 parts of water was mixed with 183.3 parts of the obtained mixture dispersion to fabricate the heat-sensitive recording coating.

The test results of the heat-sensitive recording material obtained in this example were as presented in Table 3.

### Creation of Heat-Sensitive Recording Material

The undercoat layer coating was coated on, as the support body, high quality paper (acid paper) having a basis weight of 53 g such that the mass per area after drying was 8 g/m² and dried. Then, the heat-sensitive recording coating was coated so that the mass per area after drying was 3.8 g/m², and dried. The resulting sheet was processed by a super calender such that the smoothness (JISP8155:2010) was 1000 to 1500 s to create the heat-sensitive recording material, and various tests were conducted.

### Various Tests

### 1. Heat-Sensitive Recordability Test (Color Development Test)

A heat-sensitive recording paper printing tester (TH-PMD, manufactured by Ohkura Electric Co., Ltd.) was used to print, with applied energies of 0.24 mJ/dot and 0.38 mJ/dot, on the heat-sensitive recording material created in accordance with the present disclosure. The whiteness of the background before printing, the whiteness of the background after the print energy load, and the color density of the printed portion were to be measured using a Macbeth reflection densitometer (RD-914).

Considering the contrast between the background part and the printed portion, the heat-sensitive recording material is suitable for practical use when the color density of the printed portion at the applied energy of 0.24 mJ/dot is 0.6 or more.

### 2. Powdering Confirmation Test

The printed portion resulting from the 0.38 mJ/dot applied energy obtained in the color development test is allowed to sit at rest for one hour and, then, is rubbed with a finger in order to visually observe the degree of powdering.

### Evaluation Criteria

| | |
|---|---|
| Powdering observed | Poor |
| Slight powdering observed | Good |
| No powdering observed | Very good |

### Example 2

The same operations as in Example 1 were performed with the exception of changing the 1,2-bis(phenoxy)ethane of liquid C of Example 1 to 1,2-bis(3-methylphenoxy) ethane.

The test results of the heat-sensitive recording material obtained in this example were as presented in Table 3.

### Example 3

The same operations as in Example 1 were performed with the exception of changing the liquid C of Example 1 to 69.7 parts and liquid D to 3.6 parts.

The test results of the heat-sensitive recording material obtained in this example were as presented in Table 3.

### Example 4

The same operations as in Example 1 were performed with the exception of changing the liquid C of Example 1 to 29.3 parts and liquid D to 44.0 parts.

The test results of the heat-sensitive recording material obtained in this example were as presented in Table 3.

### Example 5

The same operations as in Example 3 were performed with the exception of changing the 1,2-bis(phenoxy)ethane of liquid C of Example 3 to 1,2-bis(3-methylphenoxy) ethane.

The test results of the heat-sensitive recording material obtained in this example were as presented in Table 3.

### Example 6

The same operations as in Example 4 were performed with the exception of changing the 1,2-bis(phenoxy)ethane of liquid C of Example 4 to 1,2-bis(3-methylphenoxy)ethane.

The test results of the heat-sensitive recording material obtained in this example were as presented in Table 3

### Example 7

The same operations as in Example 1 were performed with the exception of changing the 1,2-bis(phenoxy)ethane of liquid C of Example 1 to benzyloxynaphthalene.

The test results of the heat-sensitive recording material obtained in this example were as presented in Table 4.

### Example 8

The same operations as in Example 1 were performed with the exception of changing the 1,2-bis(phenoxy)ethane of liquid C of Example 1 to oxalic acid di-p-methylbenzyl ester.

The test results of the heat-sensitive recording material obtained in this example were as presented in Table 4.

### Example 9

The same operations as in Example 7 were performed with the exception of changing the liquid C of Example 7 to 69.7 parts and liquid D to 3.6 parts.

The test results of the heat-sensitive recording material obtained in this example were as presented in Table 4.

### Example 10

The same operations as in Example 7 were performed with the exception of changing the liquid C of Example 7 to 29.3 parts and liquid D to 44.0 parts.

The test results of the heat-sensitive recording material obtained in this example were as presented in Table 4.

### Example 11

The same operations as in Example 9 were performed with the exception of changing the benzyloxynaphthalene of liquid C of Example 9 to oxalic acid di-p-methylbenzyl ester.

The test results of the heat-sensitive recording material obtained in this example were as presented in Table 4.

### Example 12

The same operations as in Example 1 were performed with the exception of changing the benzyloxynaphthalene of liquid C of Example 10 to oxalic acid di-p-methylbenzyl ester.

The test results of the heat-sensitive recording material obtained in this example were as presented in Table 4.

### Comparative Example 1

The same operations as in Example 1 were performed with the exception of using 73.3 parts of liquid D of Example 1 and not using liquid C.

The test results of this heat-sensitive recording material were as presented in Table 5.

### Comparative Example 2

The same operations as in Example 1 were performed with the exception of using 73.3 parts of liquid C of Example 1 and not using liquid D.

The test results of the heat-sensitive recording material obtained in this example were as presented in Table 5.

### Comparative Example 3

The same operations as in Example 2 were performed with the exception of using 73.3 parts of liquid C of Example 2 and not using liquid D.

The test results of the heat-sensitive recording material obtained in this example were as presented in Table 5.

### Comparative Example 4

The same operations as in Example 7 were performed with the exception of using 73.3 parts of liquid C of Example 7 and not using liquid D.

The test results of this heat-sensitive recording material were as presented in Table 5.

### Comparative Example 5

The same operations as in Example 8 were performed with the exception of using 73.3 parts of liquid C of Example 8 and not using liquid D.

The test results of this heat-sensitive recording material were as presented in Table 5.

TABLE 3

Color density

| | Measured part | 0.24 mJ | 0.38 mJ | Powdering |
|---|---|---|---|---|
| Example 1 | Background | 0.05 | | Very good |
| | Printed portion | 0.85 | 1.28 | |
| Example 2 | Background | 0.05 | | Very good |
| | Printed portion | 0.83 | 1.28 | |
| Example 3 | Background | 0.05 | | Very good |
| | Printed portion | 0.73 | 1.25 | |
| Example 4 | Background | 0.05 | | Good |
| | Printed portion | 0.69 | 1.21 | |
| Example 5 | Background | 0.05 | | Very good |
| | Printed portion | 0.70 | 1.26 | |
| Example 6 | Background | 0.05 | | Good |
| | Printed portion | 0.67 | 1.21 | |

TABLE 4

| | | Color density | | |
|---|---|---|---|---|
| | Measured part | 0.24 mJ | 0.38 mJ | Powdering |
| Example 7 | Background | 0.05 | | Very good |
| | Printed portion | 0.81 | 1.26 | |
| Example 8 | Background | 0.05 | | Very good |
| | Printed portion | 0.79 | 1.24 | |
| Example 9 | Background | 0.05 | | Very good |
| | Printed portion | 0.68 | 1.22 | |
| Example 10 | Background | 0.05 | | Good |
| | Printed portion | 0.66 | 1.20 | |
| Example 11 | Background | 0.05 | | Very good |
| | Printed portion | 0.65 | 1.23 | |
| Example 12 | Background | 0.05 | | Good |
| | Printed portion | 0.62 | 1.11 | |

TABLE 5

| | | Color density | | |
|---|---|---|---|---|
| | Measured part | 0.24 mJ | 0.38 mJ | Powdering |
| Comparative | Background | 0.05 | | Poor |
| Example 1 | Printed portion | 0.62 | 1.11 | |
| Comparative | Background | 0.05 | | Very good |
| Example 2 | Printed portion | 0.53 | 1.24 | |
| Comparative | Background | 0.05 | | Very good |
| Example 3 | Printed portion | 0.51 | 1.24 | |
| Comparative | Background | 0.05 | | Very Good |
| Example 4 | Printed portion | 0.45 | 1.20 | |
| Comparative | Background | 0.05 | | Very good |
| Example 5 | Printed portion | 0.43 | 1.18 | |

As is clear from Tables 3, 4, and 5, by using, in a heat-sensitive recording material that uses 4,4′-dihydroxydiphenylsulfone as a developer, at least one selected from 1,2-bis(phenoxy)ethane, 1,2-bis(3-methylphenoxy)ethane, benzyloxynaphthalene, and oxalic acid di-p-methylbenzyl ester as a sensitizer, and adding benzoin as a sensitization aid, it is possible to achieve an improvement in the sensitivity (the color density of the printed portion printed at an applied energy of 0.24 mJ/dot is 0.6 or greater), and provide a heat-sensitive recording material with hardly any powdering in the printed portion.

### INDUSTRIAL APPLICABILITY

The heat-sensitive recording material of the present disclosure uses 4,4′-dihydroxydiphenylsulfone, which is an inexpensive developer, and uses benzoin as a sensitization aid and, as such, provides a heat-sensitive recording material that has excellent color density and in which the powdering phenomenon does not occur and, thus, is extremely promising in terms of industrial applicability.

1. A heat-sensitive recording material comprising:
a heat-sensitive recording layer formed on a support body, the heat-sensitive recording layer comprising a basic dye that is colorless to a light color at room temperature,
a developer capable of reacting with the basic dye and colorizing as a result of heating,
a sensitizer, and
a sensitization aid,
wherein
the developer is 4,4′-dihydroxydiphenylsulfone, the sensitizer is at least one selected from 1,2-bis(phenoxy)ethane, 1,2-bis(3-methylphenoxy)ethane, benzyloxynaphthalene, and oxalic acid di-p-methylbenzyl ester, and the sensitization aid is benzoin.

2. The heat-sensitive recording material according to claim 1, wherein a compounding ratio of the sensitizer to the sensitization aid is from 98:2 to 40:60.

3. The heat-sensitive recording material according to claim 1, wherein a compounding ratio of the sensitizer to the sensitization aid is from 90:10 to 60:40.
